(19) United States
(12) Patent Application Publication
(10) Pub. No.: US 2019/0325546 A1
(43) Pub. Date: Oct. 24, 2019

(54) ON-DEMAND TRANSPORT SYSTEM FACILITATING THIRD-PARTY AUTONOMOUS VEHICLES

(71) Applicant: Uber Technologies, Inc., San Francisco, CA (US)

(72) Inventors: Leigh Hagestad, San Francisco, CA (US); Brent Goldman, San Francisco, CA (US); Mark Yen, San Francisco, CA (US); Michael Voznesensky, San Francisco, CA (US)

(21) Appl. No.: 16/389,794

(22) Filed: Apr. 19, 2019

Related U.S. Application Data
(60) Provisional application No. 62/660,582, filed on Apr. 20, 2018.

(51) Int. Cl. G06Q 50/30

(52) U.S. Cl. CPC G06Q 50/30; G05D 1/0212

(57) ABSTRACT

A network computing system can coordinate an on-demand transport service utilized by internal autonomous vehicles (AVs), third-party AVs, and human-driven vehicles. The system can receive transport requests from requesting users, where each transport request can indicate a pick-up location and a destination. The system can determine a plurality of candidate transport providers to service the respective transport request, in which the plurality of candidate transport providers can comprise at least one third-party AV. The system can determine a capability of the at least one third-party AV in servicing the respective transport request, and, based at least in part on the capability of the at least one third-party AV, select a transport provider from the plurality of transport providers to service the transport request.

### CROSS REFERENCE TO RELATED APPLICATION

This application claims the benefit of priority to U.S. Provisional Application No. 62/660,582, filed on Apr. 20, 2018, which is hereby incorporated by reference in its entirety.

### BACKGROUND

Vehicle ride-sharing platforms connect requesting users with available transport providers within any given transport service region (e.g., a metroplex such as the San Francisco Bay Area). For example, users can launch a ride service application on their mobile computing devices, which can enable them to configure and submit transport requests for a ride to any destination address within the transport service region. A backend computing system can process any given request by matching the user with a proximate available transport provider to transport the user to the desired destination. In the domain of vehicle ride-sharing, the effects of first-mover advantage have resulted in a few select ride-sharing platforms that have gained ubiquity in the ride-sharing market.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example computing system in communication with users and transport providers, in accordance with examples described herein;

FIG. 2 is a block diagram illustrating an example AV operated by a control system implementing a trip negotiator, according to examples described herein;

FIGS. 3 and 4 are flow charts describing example methods of selecting and filtering transport providers for servicing transport requests, according to examples described herein;

FIG. 5 is a block diagram illustrating a computer system for an autonomous vehicle (AV) upon which examples described herein may be implemented; and

FIG. 6 is a block diagram illustrating a computer system for network computing system managing an on-demand transport servicing platform, upon which examples escribed herein may be implemented.

### DETAILED DESCRIPTION

A network computing system that manages and coordinates a vehicle ride-sharing platform is described herein. The network computing system can include a communication interface communicating with computing devices of requesting users and transport providers throughout a transport service region. For example, the communication interface can comprise an application programming interface that links the network computing system to transport service applications executing on computing devices, such as mobile computing devices (e.g., smartphones, wearable computing devices, tablet computers, augmented reality devices, personal computers, etc.), and on-board computing systems of vehicles (e.g., AVs). The designated transport service application can comprise a vehicle-ride sharing platform managed and coordinated by an on-demand transport service entity that administrates the network computing system described throughout the present disclosure.

According to embodiments provided herein, the network computing system can facilitate third-party AVs in providing ride-sharing services throughout the transport service region. In doing so, the third-party AVs can execute the transport service application administered by the on-demand transport service entity that corresponds to the network computing system. Execution of the transport service application can cause the third-party AV to transmit location data to the network computing system, which enables the computing system to track the location of third-party AV throughout the transport service region and include the third-party AV in candidate sets of vehicles available to service transport requests from users.

Numerous challenges exist with the incorporation of third-party AV fleets into an on-demand transport service which can also provide its own internal fleet of AVs, and in various examples, can also incorporate human-driven vehicles into any given candidate set of transport providers competing to service a given transport request. For example, on-board routing software and operational autonomy grids of third-party AVs (e.g., a mapped road network on which the third-party AVs are operational) may differ from that of internal AVs. Furthermore, such on-board routing software and autonomy maps may remain proprietary despite the common use of a ubiquitous ride-sharing application as a platform for providing on-demand transport services. Other challenges can include trust in third-party AV capability in servicing a given ride request on a given route, and reliability of third-party AVs in completing matched rides for the user base of the on-demand transport service.

To address and overcome these challenges, the network computing system can coordinate on-demand transport for the transport service region by determining the capability of each third-party AV in servicing an individual transport request. Specifically, transport requests are intrinsically unique in that they typically correspond to unique pick-up locations (e.g., a user's household address) and a countless variety of possible destinations. Furthermore, while the capability of an internal AV in servicing a transport request may be known, the network computing system can perform a number of processes described herein to attain relative certainty in the capability of third-party AVs to service such transport requests.

In certain aspects, a third-party entity that manages a fleet of third-party AVs may share on-board routing and/or capability information of its third-party fleet with the network computing system, which can store this third-party information in a database for reference when determining the capability of the third-party AVs in servicing transport requests. In certain examples, the computing system can reference this third-party information to pre-filter third-party AVs, or third-party AV providers, either prior to or subsequent to receiving a transport request from the requesting user. As provided herein, the third-party information can comprise data indicating the routes, roads, maximum and minimum speeds, other performance attributes, and/or lanes upon which the third-party AVs may operate within the transport service region. Additionally, over time, the network computing system can collect and compile service quality data of any particular third-party fleet for future reference in matching the third-party AVs of that particular fleet with requesting users. In certain implementations, the network computing system can determine the capability of each third-party AV in the fleet based on historical data indicating the actual capabilities of individual AVs or the individual fleets of AVs of third-party entities, such as any operational faults and/or mechanical problems, and whether such faults and/or problems have been solved.

In various implementations, the network computing system can determine whether any particular third-party AV is capable of servicing a received transport request from a requesting user. In some examples, when the network computing system receives a transport request indicating a pick-up location and destination, the network computing can determine a set of candidate transport providers to service the transport request. This initial set of transport providers can comprise any combination of human-driven vehicles, internal AVs, and/or third-party AVs, and can be based, at least in part, on an estimated distance or time to the pick-up location. In some examples, this set of candidate transport providers can be determined based on the third-party information associated with the transport providers (e.g., of a third-party AV fleet). According to examples described herein, the network computing system can transmit a capability query to determine whether any particular third-party AV are capable of servicing the transport request. For example, the computing system can transmit the capability query to a third-party management system that owns or operates a fleet of third-party AVs. As another example, the computing system may communicate directly with the third-party AVs. In further variations, the computing system can perform a lookup in an accessible and/or internal database storing capability information of third-party AVs to determine whether the AV is capable of servicing a transport request.

According to examples described herein, the third-party information stored in the accessible/internal database of the computing system can be collected by actively querying the third-party management systems and/or the third-party AVs for capability information (e.g., prior to the third-party AVs entering the rideshare network, or in real-time as transport requests are being serviced). Additionally or alternatively, the computing system can receive this third-party information periodically from the third-party management system or the third-party AVs. For example, the third-party management systems may send updated third-party information concerning their AV fleet whenever the capability of the fleet is upgraded (e.g., expanded routing network, hardware upgrades, software updates, etc.). In other examples, the third-party management systems may send refreshed third-party information on a set schedule (e.g., once every week).

In certain examples, the network computing system can determine the most optimal route (e.g., minimizing time and/or distance) from the pick-up location to the destination indicated in the transport request, and transmit the capability query to include the determined route. In response to the capability query, the computing system can receive a capability response (e.g., from the third-party management system or the AV itself) indicating that it can or cannot service the request (e.g., based at least in part on the determined route). As another example, the capability query can more generally comprise the pick-up location and destination, and can include an inquiry regarding an estimated time of completion for the trip and/or a proposed route for the trip. In some aspects, the capability query can further include an estimated cost for completing the trip. The third-party AV can determine its own capability to undertake the transport request based on, for example, the on-board routing software and/or autonomy grid maps utilized by the third-party AV to operate throughout the transport service region. Furthermore, local factors such as how much power or fuel the vehicle currently has, any current diagnostic issues, vehicle condition (e.g., cleanliness, tire or brake wear, etc.) can be considered by the third-party AV in determining its capability of servicing a particular transport request. Additionally or alternatively, given a pick-up location and/or destination, the network computing system can query a backend, third-party fleet management system that manages or otherwise provides the third-party AV fleet for transport services to determine the capability of the third-party AV in servicing a particular transport request.

Based on the capability responses from the third-party AVs or fleet management system(s) of the third-party AVs, the network computing system can filter out the third-party AVs that are incapable of servicing the request. Additionally, the network computing system can further filter out third-party AVs that do not meet a set of quality constraints for completing the trip (e.g., the estimated duration for completion exceeds a percentage threshold when compared to an internal AV or human-driven vehicle). The result can comprise a filtered set of a combination of internal AVs, human-driven vehicles, and/or capable third-party AVs. The network computing system may then select from this filtered set of transport providers to service the transport request based on any number of factors, such as distance, time, traffic conditions, and local or global supply and demand efficiency within the transport service region. For example, the network computing system can rank the filtered set of transport providers based on a set of transport efficiency parameters that can include estimated time of completion, cost efficiency, value generated, transport service efficiency, and the like.

In variations, once the filtered set of transport providers is determined, the network computing system can ultimately select a transport provider using one or more methods. Mentioned above, the network computing system can rank the filtered set of transport providers based on any number of factors, such as distance, time, traffic, service efficiency, supply and demand efficiency, projected value generated, and the like. Such ranking can occur before and/or after transmission of the capability query. Alternatively, the network computing system can transmit a simultaneous transport invitation or choice query to each of the transport providers in the filtered set and receive a set of responses indicating whether the transport provider wishes or chooses to service the transport request. It is contemplated that the network computing system may transmit the simultaneous invitations only to the AVs in the filtered set due to the impassivity of autonomous systems in being rejected. Accordingly, based on the AV responses to the choice query, the network computing system can further filter the set of candidate transport providers and/or select an optimal transport provider from the remaining set.

It is further contemplated that any transport provider, whether human or AV, can respond to a transport invitation in the negative. For example, the network computing system can transmit transport invitations sequentially based on the ranked set of transport providers and receive a series of one or more negative responses until a transport provider responds in the affirmative. In this arrangement, the network computing system can match the first affirmatively responding transport provider in the ranked set to the transport request. In some examples, the network computing system can receive a plurality of affirmative responses and select a transport service provider from among the plurality of affirmatively responding transport providers (e.g., based on ranking, third-party information, etc.). Thereafter, the network computing system can monitor the en route progress of the transport provider to the rendezvous location with the requesting user, provide or facilitate remote assistance if needed, and facilitate a multi-trip ride to rendezvous with the user if the third-party or internal AV fails to complete the trip.

As provided herein, a transport request can comprise a request for passenger transport, comestible goods delivery, package or mail delivery, and the like. Accordingly, the network computing system described herein can apply classification filters to determine the candidate set of transport providers for any given request. For example, each transport provider can be classified as one or more of a passenger transport provider, a food delivery provider, a package delivery provider, a mail delivery provider, and the like. Thus, when tracking transport providers throughout the given region, the network computing system can utilize the provider classifications in pre-filtering the transport providers for any given transport request.

Among other benefits, the examples described herein achieve a technical effect of incorporating third-party AVs that may include differing capabilities/attributes into a single vehicle ride-sharing platform. Through inclusiveness of a diverse field of AVs, the network computing system described herein may support convergence towards safer, more efficient, and more cost-effective solutions to the current challenges in autonomous driving technology. For example, based on the capability determinations, filtering, and ranking techniques described herein, the network computing system can identify shortcomings or advantages in third-party AV fleets (as well as its own internal fleet) as compared to other fleets, and facilitate the overall improvement of autonomous vehicle capability on public roads and highways.

As used herein, a computing device refers to devices corresponding to desktop computers, computer servers, mobile computing devices or smartphones, laptop computers, tablet computing devices, virtual reality (VR) and/or augmented reality (AR) devices, wearable computing devices, etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, mobile devices or smartphones, tablet computers, laptop computers, virtual reality (VR) or augmented reality (AR) computers, and/or network equipment (e.g., routers). Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a non-transitory computer-readable medium. Machines shown or described with figures below provide examples of processing resources and non-transitory computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as those carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

As provided herein, the term “autonomous vehicle” (AV) describes any vehicle operating in a state of autonomous control with respect to acceleration, steering, braking, auxiliary controls (e.g., lights and directional signaling), and the like. Different levels of autonomy may exist with respect to AVs. For example, some vehicles may enable autonomous control in limited scenarios, such as within mapped autonomy grids or on highways. More advanced AVs, such as those described herein, can operate in a variety of traffic environments without any human assistance. Accordingly, an “AV control system” can process sensor data from the AV's sensor array, and modulate acceleration, steering, and braking inputs to safely drive the AV along a given route.

### Systems Description

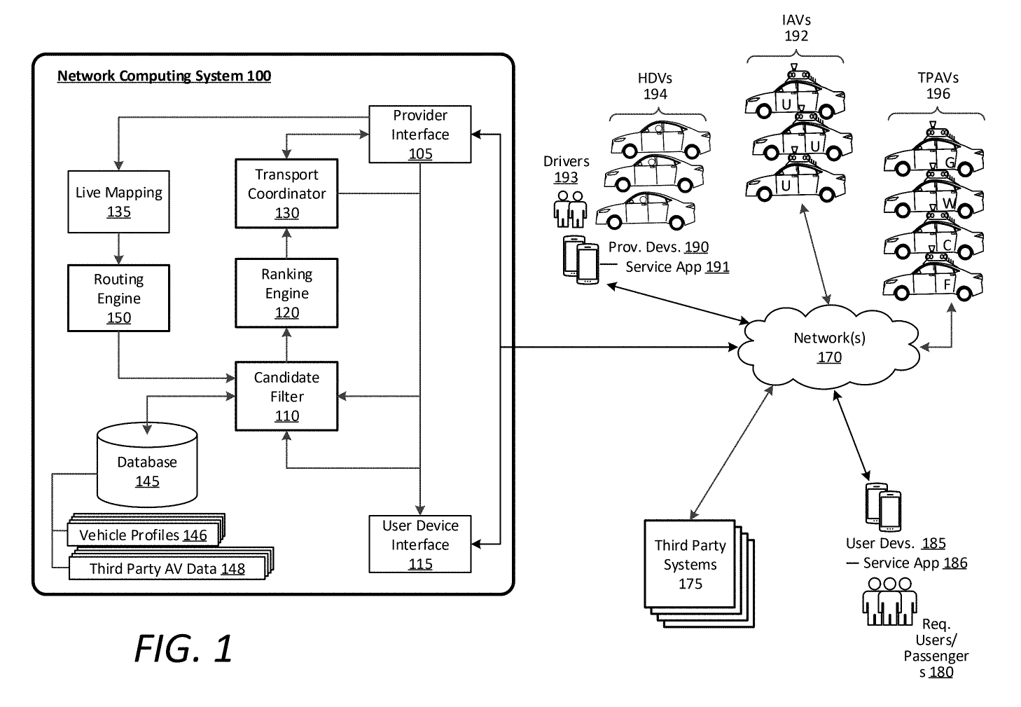

FIG. 1 is a block diagram illustrating an example network computing system in communication with users and transport providers, in accordance with examples described herein. The network computing system 100 shown and described with respect to FIG. 1 can coordinate on-demand transport for a transport service region (e.g., a metropolitan area) by receiving transport requests from requesting users 180 and matching the transport requests with available transport providers. In various implementations, the network computing system 100 can include a user device interface 115 that connects with user devices 185 over one or more networks 170 via an executed service application 186 on the user devices 185. For example, a requesting user 180 can launch the service application 186 on the user device 185 to configure and transmit transport requests to the network computing system 100. The network computing system 100 can receive the transport requests at the user device interface 115. The network computing system 100 can further include a provider interface 105 that connects the network computing system 100 with various transport providers, which can comprise human drivers 193 operating human-driven vehicles 194, a fleet of internal AVs 192 associated with the on-demand transport service managed by the network computing system 100, and any number of fleets of third-party AVs 196 owned, managed, and/or provided by any number of third-party entities.

In various examples, the provider interface 105 can connect with provider devices 190 of human drivers 193 via an executed transport service application 191 on those devices 190. Additionally, the provider interface 105 can connect with the computing system of the internal AVs 192 and third-party AVs 196 based on a transport service application executing on the on-board computing systems of those AVs 192, 196. The various transport providers can transmit location data (e.g., GPS location pings) to the network computing system 100 to enable the network computing system 100 to track the locations of the transport providers as they operate throughout the transport service region. For example, the network computing system 100 can include a live mapping engine 135 that tracks the dynamic locations of the transport providers on map data as they operate throughout the region.

According to certain implementations, the network computing system 100 can include a candidate filter 110 that can process the transport requests received from the requesting users 180 and determine a set of candidate transport providers that can potentially service the transport request. For example, the candidate filter 110 can prefilter or eliminate any transport providers that are not within a threshold distance and/or projected time to the current location of the requesting user 180 or an inputted pick-up location indicated in the transport request. Accordingly, the candidate filter 110 can receive location data from the transport providers, and in certain variations, can further determine routing information for each remaining transport provider. For example, the network computing system 100 can include a routing engine 150 that can determine the most optimal routes of each transport provider in a candidate set of transport providers to rendezvous with the requesting user. Based on the routing data from the routing engine 150, the candidate filter 110 can determine estimated arrival times for each of the candidate transport providers. Additionally, or alternatively, the network computing system 100 can prefilter transport providers based on third-party information as described herein.

In various examples, the candidate filter 110 can further communicate with each candidate transport provider to determine a capability of that transport provider in servicing the transport request. In some aspects, the candidate set of transport providers can include any combination of human driven vehicles 194, internal AVs 192, and/or third-party AVs 196. If the candidate set includes a number of third-party AVs 196, then the candidate filter 110 can transmit a capability query to each of the third-party AVs 196 to determine whether they are capable of servicing the transport request. In doing so, the candidate filter 110 can transmit the pick-up location, the user's current location, a drop-off location, and/or a mandated route between the pick-up location and drop-off location. On board the third-party AV 196, the control system of the AV 196 can determine whether the AV 196 is capable, and if so, can transmit an affirmative response back to the candidate filter 110.

In certain examples, the third-party AV 196 can also transmit contextual information regarding a route plan, estimated time of completion, estimate cost of completion, and the like. In variations, the candidate filter 110 can transmit capability inquiries to third-party systems 175 corresponding to fleet management or ownership entities that provide the respective third-party fleets for transport services. These third-party systems 175 can comprise remote computing systems and/or human operators of third-party entities that own and operate a particular fleet of AVs throughout the transport service region. In further variations, the candidate filter 110 can transmit capability queries to the third-party systems 175 to generally determine whether a particular third-party AV 196 can service a given transport request, and if so, the candidate filter can transmit a confirmation query to the third-party AV 196 to specifically determine whether that particular AV can service the request (e.g., given local conditions on the AV, such as fuel or power, a current number of passengers, and the like). Additionally or alternatively, the network computing system 100 can include a database 145 storing vehicle profiles 146 and/or third-party data 148 (e.g., on-board routing software information from entities managing or operating third-party AVs 196) indicating whether a corresponding third-party AV 196 is capable of servicing a particular transport request. In such examples, the candidate filter 110 can reference the third-party data 148 and/or vehicle profiles 146 to filter out incapable third-party AVs to output a filtered set of transport providers.

According to various implementations, the candidate filter 110 can output a filtered set of candidate transport providers to a ranking engine 120 of the network computing system 100 based on the capability responses from the third-party AVs 196 or the third-party systems 175. In certain aspects, the filtered set of transport providers can list each candidate vehicle with identifying information (e.g., type of vehicle, human-driven, internal AV, or third-party AV), an estimated time of completion, an estimated distance or time from the pick-up location, expected generated value for completing the trip, and the like. The ranking engine 120 can rank the filtered set of vehicles based on any of the foregoing factors. For example, the ranking engine 120 can attribute increased weightings to certain factors, such as the estimated time of arrival to the pick-up location, and output the ranked set of candidate transport providers to a transport coordinator 130 of the network computing system 100.

The transport coordinator 130 can operate to ultimately select and invite a transport provider to service the transport request from the ranked set of transport providers. In various examples, the transport coordinator 130 can sequentially transmit transport invitations to each transport provider in the ranked set in the order of the ranking until a ranked transport provider accepts the invitation. For example, the transport coordinator 130 can initially transmit a transport invitation to a highest ranked transport provider, and receive an invitation response either accepting or rejecting the invitation. If accepted, the transport coordinator 130 can match the transport request from the requesting user 180 with the highest ranked transport provider and enter an on-trip status for both. If rejected, then the transport coordinator 130 can transmit the invitation to a next highest ranked transport provider, and so on until a highest ranked, accepting transport provider accepts the invitation. Once accepted, the transport coordinator 130 can transmit match data to each of the accepting transport provider and the requesting user 180, and facilitate the rendezvous between them.

In variations, the transport coordinator 130 can take a highest subset of the ranked transport providers (e.g., the top three) and transmit a simultaneous transport invitation or multiple transport invitations to them. In such embodiments, the transport coordinator 130 can receive multiple acceptances and select a highest ranked transport provider from those that accepted. In further variations, the transport coordinator 130 initially transmit the transport invitation to only the internal AVs 192 and the third-party AVs 196 in the ranked set of transport providers, and receive a set of invitation responses from those AVs. If none accept, then the transport coordinator 130 can transmit the invitation to one or more of the human drivers 193 in the ranked set. However, if one or more AVs accept, then the transport coordinator 130 can select one of the AVs to service the transport request (e.g., a highest ranked affirmative respondent). Alternatively, if one or more AVs accept, the transport coordinator 130 can determine whether the accepting AVs are ranked higher or lower than a human driver 193. If the accepting AVs are ranked higher, then the transport coordinator 130 can select from the accepting AVs to service the transport request. However, if the accepting AVs are ranked lower than one or more human drivers 193, then the transport coordinator 130 can transmit the invitation to the computing devices 190 of the higher ranked drivers 193. If a driver 193 accepts, then the transport coordinator 130 can match the accepting driver 193 with the requesting user 180 that submitted the transport request.

As described herein, for any given transport request, the candidate filter 110 can compile third-party data/information 148 regarding the capability of third-party fleets in operating throughout the transport service region. In some aspects, the third-party data 148 of a particular third-party entity can indicate whether a whole fleet of third-party AVs should be disqualified or qualified (e.g., pre-filtered) as candidate vehicles for individual transport requests. For example, the third-party data 148 can describe autonomy road networks (e.g., lane-specific routes and/or route segments) that a third-party fleet of AVs is capable of servicing. Thus, if a transport request requires a transport provider to travel outside the autonomy road network of a particular fleet, then the candidate filter 110 can pre-filter or disqualify all third-party AVs in that fleet, or subsets of third-party AVs that individually cannot service the request. The third-party data 148 can also describe the attributes of the AVs (e.g., max/min speed, maneuverability, other performance attributes, etc.), which can also (or alternatively) be utilized for pre-filtering AVs.

In further examples, the candidate filter 110 can compile and access vehicle profiles 146 of individual third-party AVs 196. It is contemplated that AV technology may advance unevenly across fleets and within the fleets themselves. For example, AVs may run outdated software or carry outdated hardware, but may still be sufficiently reliable and safe for transport services. In various aspects, the vehicle profiles 146 can indicate the capability of individual AVs in servicing any given transport request. Accordingly, the candidate filter 110 can determine a candidate set of transport providers, comprising any combination of human-driven vehicles 194, internal AVs 192, and/or third-party AVs 196, and perform lookups of the vehicle profiles 146 of those candidate transport providers to determine whether each transport provider is individually capable of servicing the transport request.

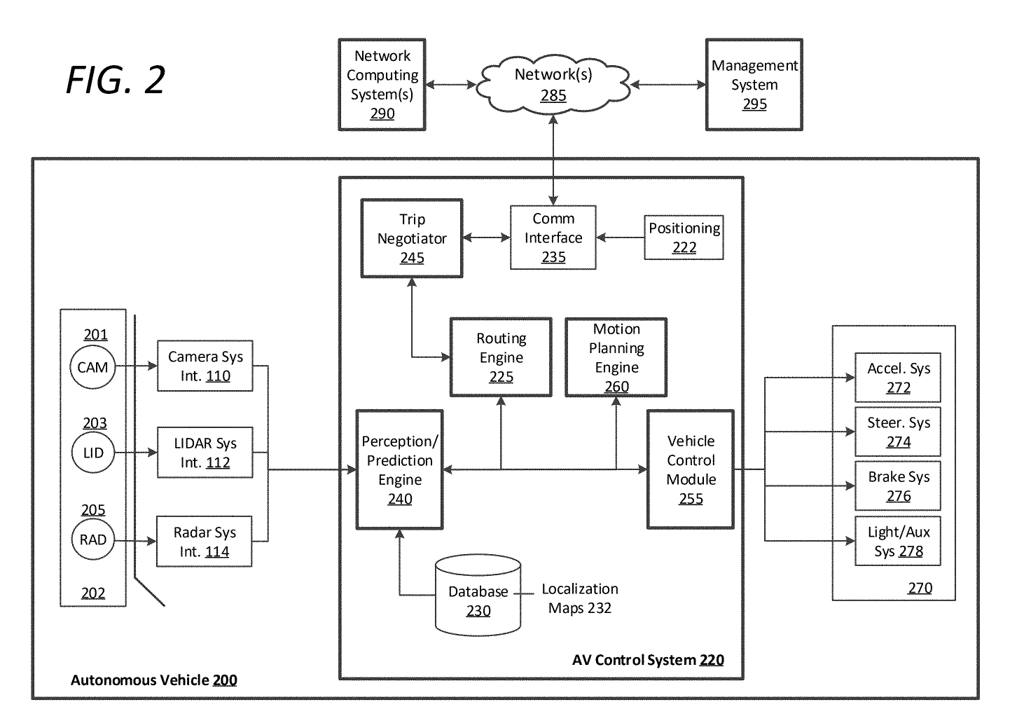

FIG. 2 is a block diagram illustrating an example AV 200 operated by a control system 220, according to examples described herein. In an example of FIG. 2, a control system 220 can autonomously operate the AV 200 in a given geographic region, and can perform transport services (e.g., transport of humans, delivery services, etc.). In examples described, the AV 200 can operate without human control. For example, the AV 200 can autonomously steer, accelerate, shift, brake, and operate lighting components without human intervention. In certain variations, the AV 200 can switch between an autonomous mode, in which the AV control system 220 autonomously operates the AV 200, and a manual mode in which a driver takes over manual control of the acceleration system 272, steering system 274, braking system 276, and lighting and auxiliary systems 278 (e.g., directional signals and headlights).

According to some examples, the control system 220 can utilize specific sensor resources in order to autonomously operate the AV 200 in a variety of driving environments and conditions. For example, the control system 220 can operate the AV 200 by autonomously operating the steering, acceleration, and braking systems 272, 274, 276 of the AV 200 to a specified destination. The control system 220 can perform vehicle control actions (e.g., braking, steering, accelerating) and route planning using sensor information, as well as other inputs (e.g., transmissions from remote or local human operators, network communication from other vehicles, etc.).

In an example of FIG. 2, the control system 220 includes computational resources (e.g., processing cores and/or field programmable gate arrays (FPGAs)) which operate to process sensor data received from a sensor system 202 of the AV 200 that provides a sensor view of a road segment upon which the AV 200 operates. The sensor data can be processed to determine actions which are to be performed by the AV 200 in order for the AV 200 to continue along a current route to the destination. In some variations, the control system 220 can include other functionality, such as wireless communication capabilities using a communication interface 235, to send and/or receive wireless communications over one or more networks 285 with one or more remote sources. In controlling the AV 200, the control system 220 can generate commands to control the various control mechanisms 270 of the AV 200, including the vehicle's acceleration system 272, steering system 274, braking system 276, and auxiliary systems 278 (e.g., lights and directional signals).

The AV 200 can be equipped with multiple types of sensors 202 which can combine to provide a computerized perception, or sensor view, of the space and the physical environment surrounding the AV 200. Likewise, the control system 220 can operate within the AV 200 to receive sensor data from the sensor suite 202 and to control the various control mechanisms 270 in order to autonomously operate the AV 200. For example, the control system 220 can analyze the sensor data 215 to generate low level commands executable by the acceleration system 272, steering system 274, and braking system 276 of the AV 200. Execution of the commands by the control mechanisms 270 can result in throttle inputs, braking inputs, and steering inputs that collectively cause the AV 200 to operate along sequential road segments to a particular destination.

In more detail, the sensor suite 202 operates to collectively obtain a sensor view for the AV 200 (e.g., in a forward operational direction, or providing a 360 degree sensor view), and to further obtain situational information proximate to the AV 200, including any potential hazards or obstacles. By way of example, the sensors 202 can include multiple sets of camera systems 201 (video cameras, stereoscopic cameras or depth perception cameras, long range monocular cameras), LIDAR systems 203, one or more radar systems 205, and various other sensor resources such as sonar, proximity sensors, infrared sensors, and the like. According to examples provided herein, the sensors 202 can be arranged or grouped in a sensor system or array (e.g., in a sensor pod mounted to the roof of the AV 200) comprising any number of LIDAR, radar, monocular camera, stereoscopic camera, sonar, infrared, or other active or passive sensor systems.

Each of the sensors 202 can communicate with the control system 220 utilizing a corresponding sensor interface 210, 212, 214. Each of the sensor interfaces 210, 212, 214 can include, for example, hardware and/or other logical components which are coupled or otherwise provided with the respective sensor. For example, the sensors 202 can include a video camera and/or stereoscopic camera system 201 which continually generates image data of the physical environment of the AV 200. The camera system 201 can provide the image data for the control system 220 via a camera system interface 210. Likewise, the LIDAR system 203 can provide LIDAR data to the control system 220 via a LIDAR system interface 212. Furthermore, as provided herein, radar data from the radar system 205 of the AV 200 can be provided to the control system 220 via a radar system interface 214. In some examples, the sensor interfaces 210, 212, 214 can include dedicated processing resources, such as provided with field programmable gate arrays (FPGAs) which can, for example, receive and/or preprocess raw image data from the camera sensor.

In general, the sensor systems 202 collectively provide sensor data to a perception/prediction engine 240 of the control system 220. In various implementations, the perception/prediction engine 240 can access a database 230 comprising stored localization maps 232 of the given region in which the AV 200 operates. The localization maps 232 can comprise detailed ground truth data of each road segment of the given region. For example, the localization maps 232 can comprise prerecorded data (e.g., sensor data including image data, LIDAR data, and the like) by specialized mapping vehicles or other AVs with recording sensors and equipment, and can be processed to pinpoint various objects of interest (e.g., traffic signals, road signs, and other static objects). As the AV 200 travels along a given route, the perception/prediction engine 240 can access a current localization map of a current road segment to compare the details of the current localization map with the sensor data in order to detect and classify any objects of interest, such as moving vehicles, pedestrians, and the like.

In various examples, the perception/prediction engine 240 can dynamically compare the live sensor data from the AV's sensor systems 202 to the current localization map as the AV 200 travels through a corresponding road segment. The perception/prediction engine 240 can flag or otherwise identify any objects of interest in the live sensor data that can indicate a potential hazard. In accordance with many examples, the perception/prediction engine 240 can output a processed sensor view indicating such objects of interest to a vehicle control module 255 of the AV 200. In further examples, the perception/prediction engine 240 can predict a path of each object of interest and determine whether the AV control system 220 should respond or react accordingly. For example, the perception/prediction engine 240 can dynamically calculate a collision probability for each object of interest, and generate event alerts if the collision probability exceeds a certain threshold. As described herein, such event alerts can be processed by the vehicle control module 255 that generates control commands executable by the various control mechanisms 270 of the AV 200, such as the AV's acceleration, steering, and braking systems 272, 274, 276.

On a higher level, the AV control system 220 can include a motion planning engine 260 that provides the vehicle control module 255 with a motion plan and a travel trajectory along a current route to a destination. The current route may be determined by a backend transport system, or may be determined by the AV 200 via access to a local or external mapping service. In some aspects, the AV 200 can include a user interface, such as a touch-screen panel or speech recognition features, which can enable a passenger to input a destination. In some aspects, the AV 200 may communicate with an on-demand transport management system that manages routing of any number of AVs operating throughout a given region to provide transportation services to requesting riders. Thus, the motion planning engine 260 may receive the destination from the on-demand transport system over the network(s) 285 in order to plan a current route for the AV 200.

In mapping the current route, the motion planning engine 260 can generally utilize an on-board mapping engine or an external mapping service by transmitting map calls over the network(s) 285 in order to determine a most optimal route plan from a current location of the AV 200 to the destination. This route plan may be determined based on distance, time, traffic conditions, additional pick-ups (e.g., for carpooling services), and the like. For each successive road segment on which the AV 200 travels, the motion planning engine 260 can provide trajectory data to the vehicle control module 255 to enable the vehicle control module 255 to operate the AV 200 safely to the next road segment or the destination. For example, the trajectory data can indicate that the vehicle control module 255 must change lanes or make a turn within the current localization map in order to proceed to the next road segment along the current route plan.

According to examples provided herein, the vehicle control module 255 can utilize the motion plan, the processed sensor view, and event alerts to autonomously operate the control mechanisms 270 of the AV 200. As an example, to make a turn based on the route plan, the vehicle control module 255 can generate control commands that cause the lights and auxiliary systems 278 of the AV 200 to activate the appropriate directional signal, the braking system 276 to slow the AV 200 down for the turn, the steering system 274 to steer the AV 200 into the turn, and the acceleration system 272 to propel the AV 200 when exiting the turn. In further examples, event alerts may indicate potential hazards such as a pedestrian crossing the road, obstacles on the road, a construction area, proximate vehicles, an upcoming traffic signal and signal state, and the like. The vehicle control module 255 can respond to each event alert on a lower level while, on a higher level, operating the AV 200 based on the motion plan determined by the motion planning engine 260.

According to examples described herein, the AV control system 220 can further include a routing engine 225, positioning module 222, and trip negotiator 245. The positioning module 222 can transmit positioning data (e.g., location pings) to the network computing system 290 to enable the computing system 290 to identify the AV 200 as a candidate for servicing transport requests. In doing so, the network computing system 290 can select the AV 200 as a candidate vehicle and as an optimal servicing vehicle to fulfill a given transport request in the manner described with respect to FIG. 1. The positioning module 222 can comprise one or more of a global positioning system (GPS) module, GLONASS module, DORIS chip, BeiDou COMPASS chip, GALILEO module, IRNSS module, QZSS, or any suitable satellite or ground positioning or navigation system.

In certain implementations, the routing engine 225 can access the localization maps 232 to determine a proposed route for servicing a particular transport request. For example, the network computing system 290 can transmit a capability inquiry to the trip negotiator 245, which can determine whether the AV 200 is able to service a given transport request, or in certain implementations, whether the transport request is desirable for the AV 200. In various aspects, given a received capability query, the trip negotiator 245 can query the routing engine 225 for a proposed route to pick-up the requesting user and transport the requesting user to the destination indicated in the transport request. In further implementations, the trip negotiator 245 can communicate with a management system 295, corresponding to a third-party system 175 that manages or owns the AV 200, to determine whether the management system 295 identifies the transport request as desirable for the AV 200 (e.g., based on cost, location, routing information, etc.).

If the transport request is undesirable, then the trip negotiator can transmit a rejection message to the network computing system 290 and await a next capability inquiry corresponding to another transport request. If the transport request is desirable, the trip negotiator 245 can transmit data indicating the propose route back to the network computing system 290. In some aspects, the trip negotiator 245 transmit additional information that indicates an estimated time of completion to service the transport request, and other parameters that may make the trip more desirable for the requesting user (e.g., any on-board amenities or features).

In various embodiments, the network computing system 290 can ultimately decide whether the AV 200 is suitable or optimal for servicing a given transport request. The network computing system 290 can transmit an initial capability inquiry to the communication interface 235, which can be processed by the trip negotiator 245. The trip negotiator 245 can transmit data indicating a proposed route, estimated completion time, and/or a confirmation or rejection that the AV 200 is capable of servicing the request back the network computing system 290 to assist the network computing system 290 in making a final decision. If the AV 200 is most optimal, the network computing system 290 can transmit a transport invitation to the trip negotiator 245 to service the transport request, which the trip negotiator 245 may accept or decline.

It is contemplated that multiple on-demand transport servicing platforms may be utilized by the AV 200, and therefore multiple transport invitations may be received near simultaneously from multiple network computing systems 290 each managing their own on-demand transport service(s). Thus, if multiple transport invitations are received from multiple computing systems 290, the trip negotiator 245 and/or management system 295 of the AV 200 can select a most desirable transport invitation to accept and reject or cancel the others. It is further contemplated that the AV 200 can operate in an available mode, an on-trip mode, and an unavailable mode for any combination of transport service at any given time (e.g., passenger transport, carpool service, food delivery, package and mail delivery, and the like). Accordingly, the trip negotiator 245 can locally, or in concert with the management system 295, determine which requests and invitations to fulfill for which particular transportation services (e.g., based on actual or projected earnings).

### Methodology

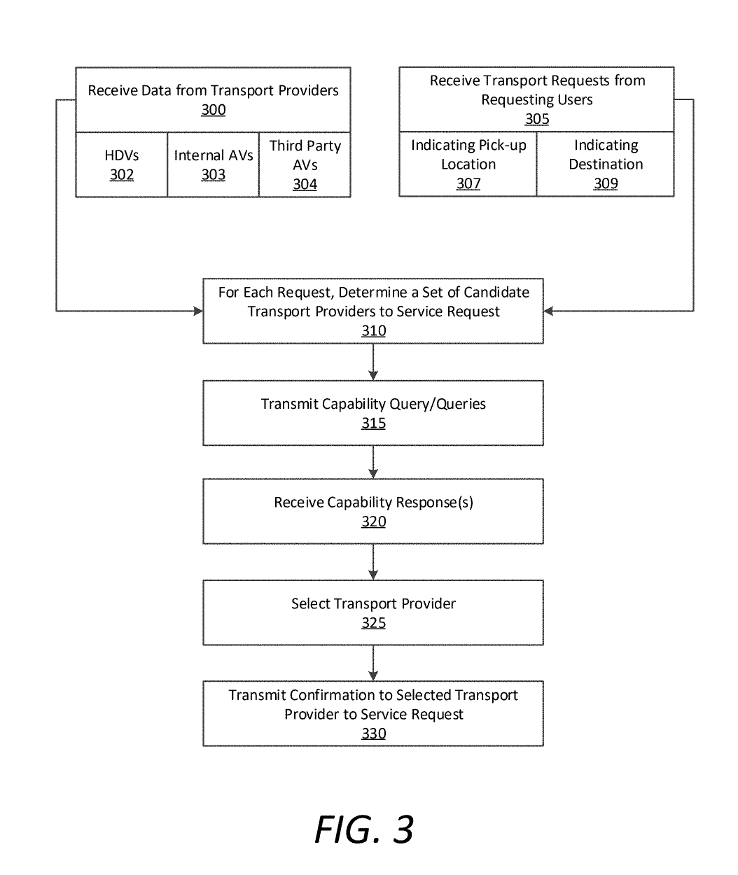

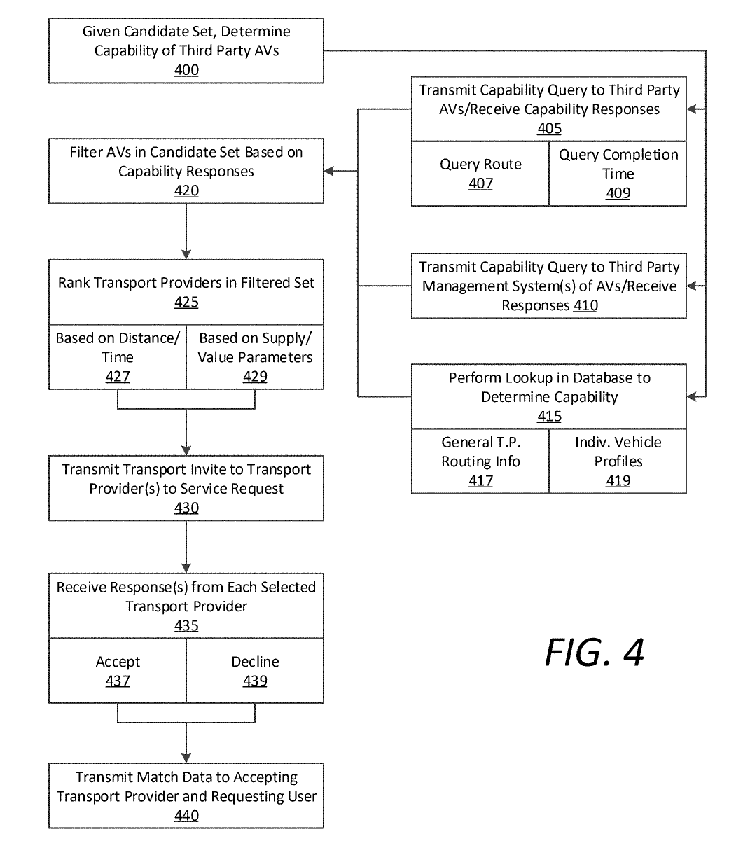

FIGS. 3 and 4 are flow charts describing example methods of filtering and selecting transport providers for servicing transport requests, according to examples described herein. In the below descriptions of FIGS. 3 and 4, reference may be made to reference characters representing like features shown and described with respect to FIGS. 1 and 2. Furthermore, the steps and processes described with respect to FIGS. 3 and 4 below may be performed by an example network computing system 100, as described herein with respect to FIG. 1. Referring to FIG. 3, the computing system 100 can receive location data from transport providers operating throughout a given region (300). As provided above, the transport providers can comprise any number of human drivers 193 operating human-driven vehicles 194 (302), internally managed AVs 192 (303), and/or third-party AVs 196 (304).

In various aspects, the network computing system 100 can receive transport requests from requesting users 180 (305). Each transport request can indicate a pick-up location (e.g., proximate to the current location of the user 180) (307) and a desired destination (309). For each transport request, the network computing system 100 can determine a set of candidate transport providers to service the request (310). In various aspects, the candidate transport providers may be determined based on distance and/or time to the pick-up location. Additionally or alternatively, the computing system 100 can determine the candidate transport providers based on a projected supply efficiency for the respective areas, or the entire region, in which the transport providers are located.

For illustration, the given region may be divided into geo-fenced sub-regions. The network-computing system 100 can determine a dynamic supply/demand ratio between transport providers and transport requests for each sub-region, and move supply between sub-regions in order to effectively homogenize the supply/demand ratio throughout the given region. Along these lines, the network computing system 100 can generally move transport providers from supply-concentrated sub-regions into supply-constrained sub-regions. Accordingly, the network computing system 100 can favor candidate transport providers in supply-concentrated or oversupplied sub-regions to service transport requests originating in supply-constrained sub-regions. In other words, when a transport request is received from a requesting user 180 within any sub-region, the network computing system 100 can generally favor transport providers located in proximate sub-regions that have more supply versus demand than the requesting user's current sub-region.

In various examples, the network computing system 100 can transmit capability queries (e.g., to the backend AV management systems or to the AVs themselves) to determine whether any third-party AVs 196 in the candidate set of transport providers can service the transport request (315). Thereafter, the computing system 100 can receive capability responses (e.g., from the third-party management system or third-party AVs 196), and filter the candidate set of transport providers accordingly (320). For example, the capability responses can indicate whether the third-party AV 196 is able to service the transport request (e.g., whether the destination or pick-up location is located outside the AV's operational domain). Any incapable AVs may then be filtered out of the candidate set, resulting in a filtered set of candidate transport providers comprising any number of human-driven vehicles 194, internal AVs 192, and/or capable third-party AVs 196. From this filtered set, the network computing system 100 can rank the filtered set and select a transport provider (325), and transmit a transport invitation to the selected transport provider to service the transport request (330).

FIG. 4 is flow chart describing a method of filtering, ranking, and selecting transport providers to service transport requests. Any step described with respect to either FIG. 3 or FIG. 4 may be performed in parallel with or replace any other step described. Furthermore, the steps provided in FIGS. 3 and 4 need not be performed in the order(s) described, but may rather be performed in any suitable order, may be performed in parallel to any other particular step, or may be omitted from the process. Referring to FIG. 4, the network computing system 100 can initially receive a transport request and determine a candidate set of transport providers, as described above. The network computing system 100 may then determine the capability of servicing the transport request for each of the third-party AVs 196 in the candidate set (400). In variations, the computing system 100 can initially pre-filter vehicles in the candidate set using data compiled over time and/or received from third-party entities with regard to their AVs, and disqualify any AVs in the candidate set that are generally determined to be incapable of servicing the transport request.

In certain implementations, the network computing system 100 can determine the capability of each AV in the candidate set by transmitting a capability query to each of the third-party AVs 196, and receiving a corresponding capability response from each of the third-party AVs 196 (405). Along with generally inquiring whether the third-party AV 196 is able to fulfill the request, each capability query can inquire a proposed route that the third-party AV 196 plans to take (407). The capability query may also inquire for an estimated completion time (409). In receiving answers to these queries, the network computing system 100 can receive additional filtering data regarding whether a candidate third-party AV 196 is more optimal (e.g., will complete the trip faster, cheaper, more efficiently, and/or more safely) to service the transport request than human-driven vehicles 194 and/or internally managed AVs 192 in the candidate set.

In variations, the network computing system 100 can transmit capability queries to the third-party management systems 175 that manage the individual third-party AVs 196, and receive capability responses from these entities (410). As described above, these capability queries can generally inquire whether the AV can service the request, a proposed route that the AV will follow to make the pick-up and drop-off, and/or an estimated time of completion. The network computing system 100 can filter the candidate set based on the responses from the third-party management systems 175.

In certain variations or in addition to the foregoing methods, the network computing system 100 can perform lookups in a local or remote database 145 to determine the capabilities of the third-party AVs (415). For example, the network computing system 100 can parse through third-party data 148 shared by fleet management entities that provide the third-party AVs 196 for transport services (417), and/or individual vehicle profiles 146 of each third-party AV 196 that can indicate software versions, on-board routing information, hardware configurations, any qualifications, and the like (419).

In additional examples, the network computing system 100 can further query the internal AVs 192 in the candidate set in the manner described above. Accordingly, the network computing system 100 may also filter the internal AVs 192 based on the capability responses received from them.

Upon determining the capabilities of each third-party AV 196 and/or internal AV 192 in the candidate set, the network computing system 100 can filter the third-party AVs 196 and/or internal AVs 192 (420). For example, the network computing system 100 can eliminate any incapable AVs from the candidate set. In further aspects, the network computing system 100 can filter out any AVs that do not meet certain threshold constraints, such as an estimated completion time threshold (e.g., 110% time from the lowest estimated completion time), certain routing constraints (e.g., follows an abnormal or inefficient route), or any number of supply efficiency parameters described herein (e.g., AVs and/or human-driven vehicles in supply-constrained sub-regions may be filtered out).

In certain aspects, the network computing system 100 can rank the remaining filtered set of transport providers (425). The ranking may be based on distance and/or estimated time (e.g., given current traffic conditions) to the pick-up location (427). Additionally or alternatively, the ranking may be based on a number of supply and/or value parameters, such as supply/demand ratios in proximate sub-regions and/or within the sub-region in which the transport provider is located, expected generated value for each transport provider, supply movement, and any amenities local to the transport provider (e.g., entertainment services) (429). Based on the ranking, the network computing system 100 can transmit a transport invitation to one or more selected transport provider(s) to service the transport request (430). For example, the computing system 100 can simultaneously transmit the invitation to the top three ranked transport providers. In variations, the network computing system 100 can sequentially transmit the transport invitation to the top ranked transport provider until accepted.

The network computing system 100 can receive responses from each of the selected transport providers (435). Each response may indicate whether the transport provider accepts (437) or declines (439) the transport invitation. For simultaneous invitation transmission, if multiple acceptances are received, the network computing system 100 can select the highest ranked, accepting transport provider to ultimately service the transport request. For sequentially transmitted invitations, the network computing system can select a first accepting transport provider to service the transport request. Once a highest ranked, accepting transport provider is selected, the network computing system 100 can transmit match data to the accepting transport provider and the requesting user 180 to facilitate the rendezvous. For example, the network computing system 100 can provide estimated time of arrival information to the requesting user and identifying information of the selected transport provider (e.g., vehicle make, model, and license plate number).

Effectively, the network computing system 100 can manage and coordinate the on-demand transport servicing platform in the manner(s) described above. In doing so, the network computing system 100 can facilitate third-party AVs 196 on the platform, and move transport supply between sub-regions to increase homogeneity and value to requesting users 180.

### Hardware Diagrams

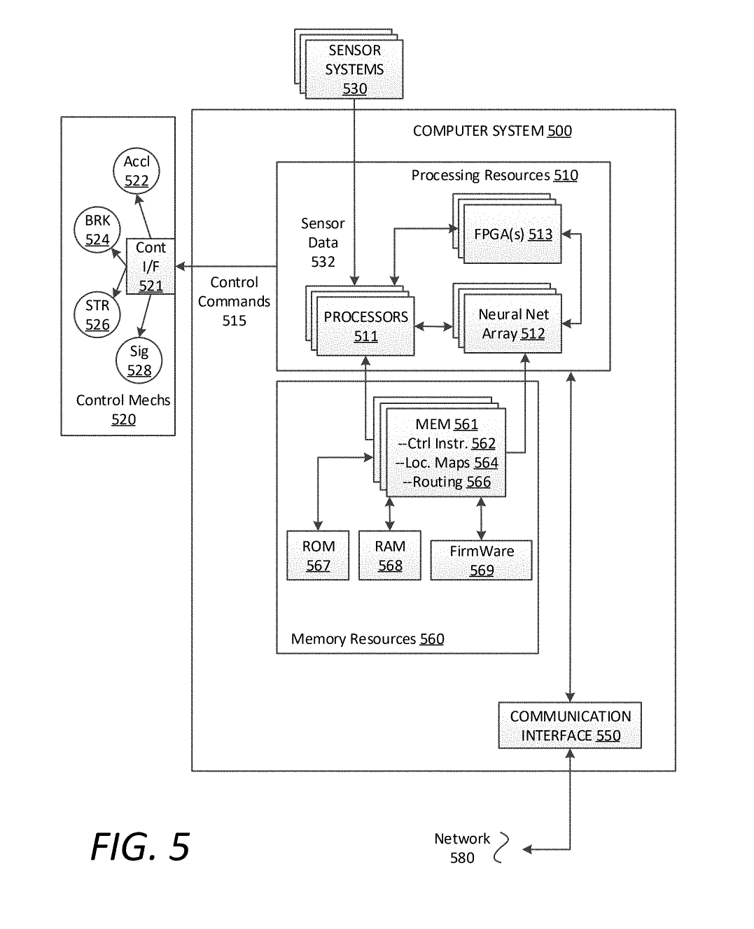

FIG. 5 is a block diagram illustrating a computer system upon which example AV processing systems described herein may be implemented. The computer system 500 can be implemented using a number of processing resources 510, which can comprise processors 511, field programmable gate arrays (FPGAs) 513. In some aspects, any number of processors 511 and/or FPGAs 513 of the computer system 500 can be utilized as components of a neural network array 512 implementing one or more machine learning models and utilizing road network maps stored in memory 561 of the computer system 500. In the context of FIG. 2, various aspects and components of the AV control system 220 can be implemented using one or more components of the computer system 500 shown in FIG. 5.

According to some examples, the computer system 500 may be implemented within an autonomous vehicle (AV) with software and hardware resources such as described with examples of FIG. 2. In an example shown, the computer system 500 can be distributed spatially into various regions of the AV, with various aspects integrated with other components of the AV itself. For example, the processing resources 510 and/or memory resources 560 can be provided in a cargo space of the AV. The various processing resources 510 of the computer system 500 can also execute control instructions 562 using microprocessors 511, FPGAs 513, a neural network array 512, or any combination of the same. In addition, the computer system 500 may be in communication with a passenger feedback system 590 of the AV, which can include a feedback controller 592 comprising a set of processing and local memory resources storing feedback instructions.

In an example of FIG. 5, the computer system 500 can include a communication interface 550 that can enable communications over a network 580. In one implementation, the communication interface 550 can also provide a data bus or other local links to electro-mechanical interfaces of the vehicle, such as wireless or wired links to and from control mechanisms 520 (e.g., via a control interface 521), sensor systems 530, and can further provide a network link to a backend transport management system or a remote assistance system (implemented on one or more datacenters) over one or more networks 580.

The memory resources 560 can include, for example, main memory 561, a read-only memory (ROM) 567, storage device, and cache resources. The main memory 561 of memory resources 560 can include random access memory (RAM) 568 or other dynamic storage device, for storing information and instructions which are executable by the processing resources 510 of the computer system 500. The processing resources 510 can execute instructions for processing information stored with the main memory 561 of the memory resources 560. The main memory 561 can also store temporary variables or other intermediate information which can be used during execution of instructions by the processing resources 510. The memory resources 560 can also include ROM 567 or other static storage device for storing static information and instructions for the processing resources 510. The memory resources 560 can also include other forms of memory devices and components, such as a magnetic disk or optical disk, for purpose of storing information and instructions for use by the processing resources 510. The computer system 500 can further be implemented using any combination of volatile and/or non-volatile memory, such as flash memory, PROM, EPROM, EEPROM (e.g., storing firmware 569), DRAM, cache resources, hard disk drives, and/or solid-state drives.

The memory 561 may also store localization maps 564 in which the processing resources 510—executing the control instructions 562—can continuously compare to sensor data from the various sensor systems 530 of the AV. Execution of the control instructions 562 can cause the processing resources 510 to generate control commands 515 in order to autonomously operate the AV's acceleration 522, braking 524, steering 526, and signaling systems 528 (collectively, the control mechanisms 520). Thus, in executing the control instructions 562, the processing resources 510 can receive sensor data 532 from the sensor systems 530, dynamically compare the sensor data 532 to a current localization map 564, and generate control commands 515 for operative control over the acceleration, steering, and braking of the AV. The processing resources 510 may then transmit the control commands 515 to one or more control interfaces 521 of the control mechanisms 520 to autonomously operate the AV through road traffic on roads and highways, as described throughout the present disclosure.

The memory 561 may also store routing information 566 that the processing resources 510 can utilize to determine routes for the AV to any given destination. In certain examples described herein, the routing information 566 can further be provided to a network computing system 100 to enable the network computing system 100 to select or filter out the AV as a candidate to service transport requests.

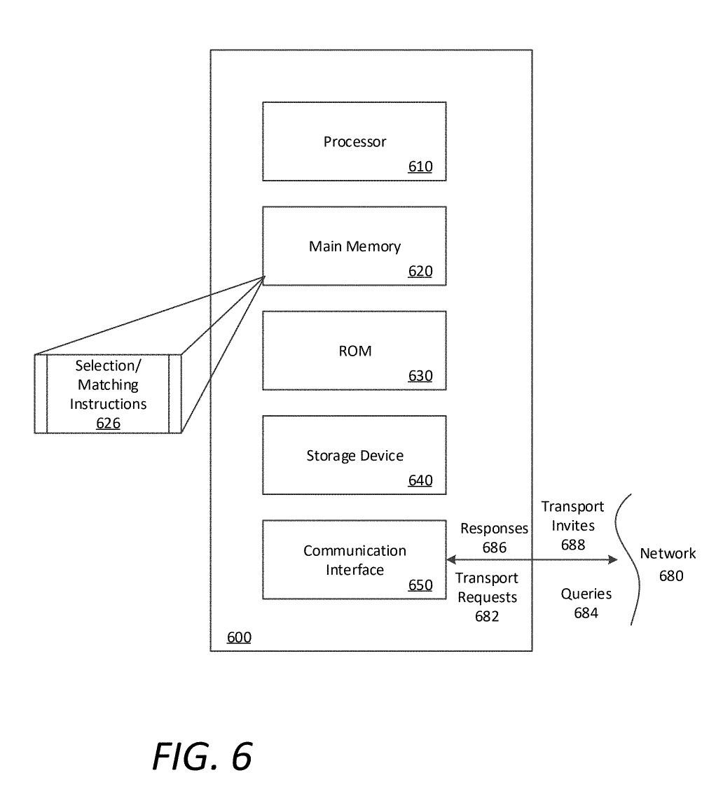

FIG. 6 is a block diagram that illustrates a computer system upon which examples described herein may be implemented. A computer system 600 can be implemented on, for example, a server or combination of servers. For example, the computer system 600 may be implemented as part of a network service for providing transportation services. In the context of FIGS. 1 and 2, the network computing system 100, 290 may be implemented using a computer system 600 such as described by FIG. 6.

In one implementation, the computer system 600 includes processing resources 610, a main memory 620, a read-only memory (ROM) 630, a storage device 640, and a communication interface 650. The computer system 600 includes at least one processor 610 for processing information stored in the main memory 620, such as provided by a random-access memory (RAM) or other dynamic storage device, for storing information and instructions which are executable by the processor 610. The main memory 620 also may be used for storing temporary variables or other intermediate information during execution of instructions to be executed by the processor 610. The computer system 600 may also include the ROM 630 or other static storage device for storing static information and instructions for the processor 610. A storage device 640, such as a magnetic disk or optical disk, is provided for storing information and instructions.

The communication interface 650 enables the computer system 600 to communicate over one or more networks 680 (e.g., cellular network) through use of the network link (wireless or wired). Using the network link, the computer system 600 can communicate with one or more computing devices, one or more servers, and/or one or more autonomous vehicles. The executable instructions stored in the memory 620 can include selection and matching instructions 626, which enables the computer system 600 to receive transport requests 682 from drivers and AVs operating throughout the given region. In some aspects, execution of the selection and matching instructions 626 can cause the computer system 600 to identify candidate transport providers, transmit capability queries 684 to those providers, receive capability responses 686, filter the candidate sets, and transmit transport invitations to matched transport providers.

The processor 610 is configured with software and/or other logic to perform one or more processes, steps and other functions described with implementations, such as described with respect to FIGS. 1-4, and elsewhere in the present application. Examples described herein are related to the use of the computer system 600 for implementing the techniques described herein. According to one example, those techniques are performed by the computer system 600 in response to the processor 610 executing one or more sequences of one or more instructions contained in the main memory 620. Such instructions may be read into the main memory 620 from another machine-readable medium, such as the storage device 640. Execution of the sequences of instructions contained in the main memory 620 causes the processor 610 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature. Thus, the absence of describing combinations should not preclude claiming rights to such combinations.

What is claimed is:

1. A network computing system comprising:
a communication interface communicating with computing devices of requesting users and transport providers throughout a transport service region;
one or more processors; and
one or more memory resources storing instructions that, when executed by the one or more processors, cause the network computing system to:
coordinate an on-demand transport service utilized by internal autonomous vehicles (AVs), third-party AVs, and human-driven vehicles;
receive, via the communication interface, transport requests from requesting users throughout the transport service region, each respective transport request from each requesting user indicating a pick-up location and a destination;
determine a plurality of candidate transport providers to service the respective transport request, the plurality of candidate transport providers comprising at least one third-party AV;
determine a capability of the at least one third-party AV in servicing the respective transport request; and
based at least in part on the capability of the at least one third-party AV, select a transport provider from the plurality of transport providers to service the respective transport request.

2. The network computing system of claim 1, wherein the executed instructions cause the network computing system to determine the plurality of candidate transport providers based on at least one of distance to the pick-up location or an estimated time of arrival to the pick-up location.

3. The network computing system of claim 1, wherein the executed instructions cause the network computing system to determine the capability of the at least one third-party AV by transmitting a capability query to the at least one third-party AV and receiving a capability response from each of the at least one third-party AV.

4. The network computing system of claim 3, where the capability response indicates an estimated time of completion for servicing the respective transport request.

5. The network computing system of claim 3, wherein the capability response indicates a proposed route for servicing the respective transport request.

6. The network computing system of claim 1, wherein the executed instructions cause the network computing system to determine the capability of the at least one third-party AV by transmitting a capability query to a third-party system that manages the at least one third-party AV.

7. The network computing system of claim 1, wherein the executed instructions further cause the network computing system to:
receive, from one or more third-party systems that manage the third-party AVs, third-party information indicating general capabilities of the third-party AVs;
wherein the executed instructions cause the network computing system to determine the capability of the at least one third-party AV based at least in part on the third-party information corresponding to the at least one third-party AV.

8. The network computing system of claim 1, wherein the executed instructions cause the network computing system to determine the capability of by sequentially transmitting a capability query to each internal AV and third-party AV of the plurality of candidate transport providers.

9. The network computing system of claim 1, wherein the executed instructions further cause the network computing system to:
determine a capability of each internal AV of the plurality of candidate transport providers;
wherein the executed instructions cause the network computing system to further select the selected transport provider based the capability of each internal AV of the plurality of candidate transport providers.

10. The network computing system of claim 9, wherein the executed instructions further cause the network computing system to:
based on the capability of each internal AV and each third-party AV, filter the plurality of candidate transport providers to generate a filtered set of transport providers; and
rank the filtered set of transport providers based on a set of value parameters;
wherein the executed instructions cause the network computing system to select the selected transport provider from the ranked and filtered set of transport providers.

11. A non-transitory computer readable medium storing instructions that, when executed by one or more processors, cause the one or more processors to:
coordinate an on-demand transport service utilized by internal autonomous vehicles (AVs), third-party AVs, and human-driven vehicles;
receive, via a communication interface, transport requests from requesting users throughout the transport service region, each respective transport request from each requesting user indicating a pick-up location and a destination;
determine a plurality of candidate transport providers to service the respective transport request, the plurality of candidate transport providers comprising at least one third-party AV;
determine a capability of the at least one third-party AV in servicing the respective transport request; and
based at least in part on the capability of the at least one third-party AV, select a transport provider from the plurality of transport providers to service the respective transport request.

12. The non-transitory computer readable medium of claim 11, wherein the executed instructions cause the one or more processors to determine the plurality of candidate transport providers based on at least one of distance to the pick-up location or an estimated time of arrival to the pick-up location.

13. The non-transitory computer readable medium of claim 11, wherein the executed instructions cause the one or more processors to determine the capability of the at least one third-party AV by transmitting a capability query to the at least one third-party AV and receiving a capability response from each of the at least one third-party AV.

14. The non-transitory computer readable medium of claim 13, where the capability response indicates an estimated time of completion for servicing the respective transport request.

15. The non-transitory computer readable medium of claim 13, wherein the capability response indicates a proposed route for servicing the respective transport request.

16. The non-transitory computer readable medium of claim 11, wherein the executed instructions cause the one or more processors to determine the capability of the at least one third-party AV by transmitting a capability query to a third-party system that manages the at least one third-party AV.

17. The non-transitory computer readable medium of claim 11, wherein the executed instructions further cause the one or more processors to:
receive, from one or more third-party systems that manage the third-party AVs, on-board routing information indicating routing capabilities of the third-party AVs;
wherein the executed instructions cause the one or more processors to determine the capability of the at least one third-party AV based on the on-board routing information corresponding to the at least one third-party AV.

18. The non-transitory computer readable medium of claim 11, wherein the executed instructions cause the one or more processors to determine the capability of by sequentially transmitting a capability query to each internal AV and third-party AV of the plurality of candidate transport providers.

19. The non-transitory computer readable medium of claim 11, wherein the executed instructions further cause the one or more processors to:
determine a capability of each internal AV of the plurality of candidate transport providers;
wherein the executed instructions cause the one or more processors to further select the selected transport provider based the capability of each internal AV of the plurality of candidate transport providers.

20. A computer-implemented method for coordinating transport, the method being performed by one or more processors and comprising:
coordinating an on-demand transport service utilized by internal autonomous vehicles (AVs), third-party AVs, and human-driven vehicles;
receiving, via a communication interface, transport requests from requesting users throughout the transport service region, each respective transport request from each requesting user indicating a pick-up location and a destination;
determining a plurality of candidate transport providers to service the respective transport request, the plurality of candidate transport providers comprising at least one third-party AV;
determining a capability of the at least one third-party AV in servicing the respective transport request; and
based at least in part on the capability of the at least one third-party AV, selecting a transport provider from the plurality of transport providers to service the respective transport request.
